(19) United States
(12) Patent Application Publication
(10) Pub. No.: US 2007/0155395 A1
(43) Pub. Date: Jul. 5, 2007

(54) Scheduling mobile users based on cell load

(76) Inventors: Nandu Gopalakrishnan, Chatham, NJ (US); Sudhir Ramakrishna, New York, NY (US); Alexandro Salvarani, Edison, NJ (US)

Correspondence Address: CARLSON, GASKEY & OLDS, P.C., 400 W MAPLE RD, SUITE 350, BIRMINGHAM, MI, 48009, US

(21) Appl. No.: 11/321,721

(22) Filed: Dec. 29, 2005

(51) Int. Cl. H04Q 7/20

(52) U.S. Cl. 455/453

(57) ABSTRACT

A scheduling strategy utilizes a total call load metric in place of a reverse signal strength indicator metric for managing reverse link resources. In a disclosed example, a load control module (40) measures the reverse signal strength indicator (62) and measures an active call load (64) using known techniques. A relationship between the reverse signal strength indicator, the active cell load, an other cell load component and a jammer component provides the ability to determine the other cell load component and the jammer component. Once the other cell load component has been determined, a total call load based upon the active cell load component and the other cell load component provides a useful metric for allocating reverse link resources between existing users and for determining whether to allow a new user, for example. In a disclosed example, the total call load at a time for scheduled transmission is estimated based upon recently measured values. The total call load provides an ability to determine an available reverse link resource, which provides an ability to determine how to schedule users desiring to transmit on the reverse link.

### FIELD OF THE INVENTION

This invention generally relates to communications. More particularly, this invention relates to wireless communication systems.

### DESCRIPTION OF THE RELATED ART

Wireless communication systems are well known. Mobile stations, such as cell phones, laptop computers or personal digital assistants communicate with base stations that are part of a wireless communication network. As known, base stations are strategically placed to provide wireless communication coverage over selected geographic areas. A variety of control mechanisms are required to maintain useful and reliable communication between mobile stations and base stations. One area where appropriate control is required is maintaining the interference level on a reverse link, which corresponds to a link from the mobile stations to the base station, within acceptable levels to avoid interference that would degrade the quality of service for mobile subscribers. A scheduling algorithm typically schedules mobile station transmissions on the reverse link to the base station to manage use of RF resources.

One contribution to reverse link interference is the result of more than one mobile station transmitting signals to a base station on the carrier. This type of interference can be referred to as call load interference.

Mobiles in wireless networks communicate with base stations by transmitting on one of multiple frequency bands. The set of frequency bands allocated for transmission is called the frequency spectrum, which is owned by wireless service providers for commercial use. In CDMA and UMTS wireless networks, mobiles communicate with a base station by transmitting on a common frequency band that is shared by many mobiles. This frequency band is called the CDMA/UMTS carrier, and has the value of 1.25 MHz for IS-95A/B, CDMA-2000, 3G1x EVDO and 3G1X EVDV and the value of 3.84 MHz for UMTS, for example.

As users are added to a carrier, or existing users transmit at higher data rates in the same carrier, the level of interference measured at the base station increases. An increase of RF interference typically forces all active mobiles in the carrier to transmit at a higher power to maintain the quality of service of their respective links. Every time a new user is added, or a user transmits at higher data rate, the average power transmission of all the other users in the carrier increases to maintain their own quality of service. Mobiles that are transmitting near their maximum power suffer a degraded quality of service when new users are added to the carrier, or existing users in the carrier increase their rate of data transmission. This situation should be detected and preferably avoided to control and minimize the rate of call drops, maintain adequate data throughput to users, preserve the quality of service perceived by the mobile users, and preserve the reverse link coverage.

If the reverse link interference due to CDMA/UMTS mobiles increases to very high values, generally the reverse link power control mechanism becomes unstable. Small fluctuations in the reverse link load in the carrier can generate large variations of the power received at the base station. In the extreme case that too many users are added to a carrier, the interference generates large burst of errors in the reverse link transmissions, leading to loss of data throughput and large amounts or retransmissions. In the worst case it leads to call drops and discontinuity of service. For instance, when the load is very high, admitting one more voice call may generate enough increase in interference that existing mobiles may drop their links to the base station because they cannot be heard reliably.

The call load in the reverse link should be monitored continuously and be maintained below safety margins to avoid instabilities associated with large fluctuations in the power received at the base station. This is typically done by measuring and comparing the total power received at the base station against a threshold.

The process of controlling the reverse link RF interference is called reverse link overload control, or “overload control.” An effective overload control requires accurate measurements of the load at a high rate. In the case of reverse link high speed packet data traffic, the same metric used by an overload control algorithm to grant or deny access, is used to schedule the rate of packet data users requesting RF resources. In the typical case, the scheduler requires a relatively precise measurement of the load in the whole range of the allowed load values. The overload control algorithm, on the other hand, only needs to know when the load is near a threshold or safety limit. Since the performance of the scheduler depends on the ability to assign data rates very quickly (on the order of 10 milliseconds, which is the minimum duration of a frame to transmit packet data), the scheduler must receive an accurate load metric at a rate of approximately 100 Hz in order to assign the available RF resources efficiently.

An efficient overload control and packet data scheduler needs an accurate call load metric at a high rate in order to utilize and assign the available RF resources as efficiently as possible. Failure to meet these requirements will degrade the performance of the overload control and scheduler algorithms. This leads to noticeable degradation of the link performance including reduced user and carrier data throughputs, reduced capacity, large latency in the data transmissions, call and sessions drops and discontinuity of service.

Additionally, jammers such as non CDMA or UMTS sources of power that contribute to the RF interference preferably will be dealt with directly by the overload control and the scheduler. Jammers will increase the interference at the base station but typically should not be included in the load calculation because they do not add to the instability of any interference. Therefore, an efficient overload control and scheduler would preferably use a load metric that is capable of measuring the jammer component in the total interference.

The typical metric associated with reverse link loading is the Reverse Signal Strength Indicator (RSSI). As it is well known, the RSSI is not the metric of choice when allocating RF resources, but it provides complementary knowledge of the reverse link RF conditions. For example, when a jammer raises the RSSI and there are no users in the carrier, the jammer may be high enough to bring the RSSI above the blocking threshold in the carrier. If the overload algorithm is based exclusively on the noise rise (RSSI over thermal noise at the receiver), then users requesting RF resources close to the base station will be blocked, even when there is no load in the system and even if the user has sufficient power to overcome the interference. In other words, failure to measure the contribution of a jammer may lead to false alarms in the overload control or underestimating of the rate assigned to packet users. RSSI is not an ideal overload trigger, in part, because it does not distinguish call load interference from jammer interference.

Three main components contribute to the RSSI: thermal noise, jammers and CDMA/UMTS traffic. The thermal noise is the background level of interference present at the receiver in all the RSSI measurements. This measurement usually remains constant during operation of a cell, or at least for a long period of time when compared to the life of a data transmission session. Jammers are external sources of power that contribute to the RSSI but not to the call load. Jammers can change their strength quickly but typically remain constant for long periods of time. Jammers do not respond to power control messages from cells. Examples of jammer sources are “human made noise,” or a GSM mobile transmitting in the reverse link in a far cell in the same carrier but with a good path loss to the base station. There is no known way to distinguish thermal noise from jammers for purposes of overload or scheduling control.

The call load component of RSSI, which results from CDMA/UMTS traffic, is divided into two categories: the “active cell” (also known as “same cell”) interference and the “other cell” interference. The “active cell” interference corresponds to the amount of power received at the base station from mobiles that are power controlled by the base station. Soft and softer handoff mobiles are included in the active cell interference category. The “other cell” interference is the amount of power from all the other mobiles transmitting in the reverse link carrier that are power controlled by neighbor base stations. These are not controlled by the base station under observation.

In practice, only the call load associated with the “active cell” traffic can be measured. One reason for using the RSSI as a metric for reverse link load management instead of call load is that the call load contribution from “other cells” typically can only be measured using complex and costly-to-implement algorithms. Conventional wisdom was that active load and other cell load were coupled or correlated. Simulations and testing have shown that assuming a proportional relationship between the active and other cell load is not accurate. This is a significant shortcoming because the other cell term, which is only weakly correlated with the active cell component, contributes to the increase in RF instability of the carrier. The amount of other cell interference can be large, and varies quickly with neighbor cell activity.

The total call load X^{total} is a measure of the CDMA/UMTS RF utilization in the reverse link. For a given sector i, the total call load is given by

$${X}_{i}^{total} = \frac{{P}_{cdma , i}}{{WI}_{o , i}} = \frac{{\sum }_{j ∈ {A}_{i}} {E}_{i , j}}{{I}_{o , i}} + \frac{{\sum }_{j ∉ {A}_{i}} {E}_{i , j}}{{I}_{o , i}} ≡ {X}_{i}^{act} + {X}_{i}^{oc} \qquad ( 1 )$$

where
Aᵢ=the set of all mobiles having an active set that contains sector i;
P_{cdma,i}=total power measured at base station i due to all the CDMA/UMTS mobiles transmitting in the carrier;
I_{o,i}=total power spectral density measured at base station i in the CDMA/UMTS carrier;
w=CDMA/UMTS carrier bandwidth;
E_{i,j}=chip energy of user j measured at base station i;
Xᵢ^{act}=active call load measured in sector i due to all the active mobiles in sector i; and
Xᵢ^{oc}=“other cell” call load in sector i due to mobiles in neighbor sectors of sector i .

As defined in equation (1), the total call load is a dimensionless quantity of range 0≦Xᵢ^{total}≦1. A value of zero means there are no CDMA/UMTS users in sector i. If the total call load value is near 1, then most of the reverse link interference in the carrier is due to CDMA/UMTS mobiles. In this case the system is approaching the pole capacity condition. The total call load can be separated into the sum of two components: the active and the “other cell” call load as shown in equation (1). Although both quantities can be measured at the base station, in practice only the active component is directly measurable. The “other cell” call load is difficult to determine, because it requires the knowledge of all the user codes that are active in the neighbor cells, which are not known by the base station in observation. Therefore, only a lower bound of the total call load is available, which is equal to the active call load in the carrier.

Since the pole instability depends on the total call load and not on the active call load alone, it is not sufficient to measure the active call load to obtain an accurate metric for overload control and reverse link scheduling. It would be desirable to be able to determine the “other cell” call load component in order to be able to obtain at least an estimate of the total call load.

If the call load metric is estimated incorrectly, or inaccurately, only suboptimal tradeoffs can be achieved when assigning reverse link data rates, while trying to maintain the quality of service for existing users. A realistic model that computes the total call load must take into account rapid variations of the “other cell” interference. Attempts to ignore the “other cell” component in the call load will invariably give an underestimation of the call load, which will have to be compensated to protect the quality of service of voice and data users. This will lead to a sub-optimal tradeoff degrading the individual data throughput, and finally the sector throughput performance. Therefore, there is a need for a reliable method to determine the total call load including the important “other cell” components. There is also a need for an improved scheduling technique that utilizes total call load information for scheduling.

### SUMMARY OF THE INVENTION

This invention addresses the need for using total call load as a scheduling metric to provide better scheduling techniques.

An exemplary method of communicating includes determining a total call load associated with a reverse link and scheduling at least one mobile station for transmission on the reverse link based upon at least the determined total call load.

One example includes determining an available reverse link resource based upon the determined total call load. The determined available resource is then used to determine how many users to schedule for transmission on the reverse link.

Another example includes determining a priority of mobile stations for scheduling based upon a predicted signal to noise ratio at a scheduled time for transmission. One example includes using selected recent power commands to a mobile station when determining the priority. The recent power commands provide an indication of what power the mobile station will use for the scheduled transmission.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a wireless communication system incorporating an embodiment of this invention.

FIG. 2 is a flow chart diagram summarizing one example approach consistent with an embodiment of this invention.

FIG. 3 is another flow chart diagram summarizing another example approach consistent with an embodiment of this invention.

### DETAILED DESCRIPTION

This invention provides an ability to accurately estimate or determine the total call load X^{total} at a high rate. Additionally, this invention provides an ability to estimate or determine the noise floor plus jammer (N₀+J) contribution to reverse link interference. These two quantities can strategically be used as the input data for base station algorithms to manage the reverse link RF resources in the air interface. The determined total call load X^{total} and noise floor plus jammer (N₀+J) metrics are useful for reverse link interference overload control, scheduling and rate control of data users (e.g. packet data), protecting reverse link coverage, detecting excessive cell interference from neighbor sectors, estimating thermal noise floor, and detecting and reporting external jammers in the carrier, for example. With this invention, more accurate load determination and scheduling is possible compared to previous systems that relied upon RSSI as the control metric.

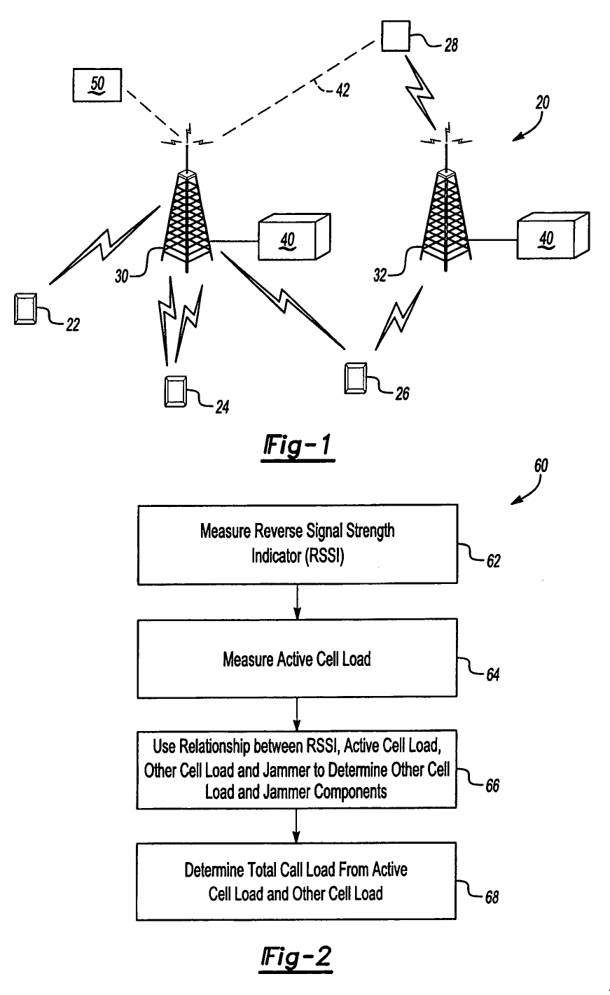

FIG. 1 schematically shows selected portions of an example wireless communication system 20. A plurality of mobile stations 22, 24, 26 and 28 communicate with one or more base stations 30, 32. In the illustrated example, the mobile station 22 is communicating with the base station 30. The example mobile station 24 is in a softer handoff mode switching between sectors that are both served by the base station 30. The example mobile station 26 is in a soft handoff mode between the base stations 30 and 32. The example mobile station 28 is in communication with the base station 32.

The example base stations 30 and 32 include a scheduler and reverse link load control module 40 that includes suitable programming for monitoring the interference level on a reverse link for a given carrier or within a given sector. This description refers to reverse link load control on a carrier. The principles associated with the disclosed example are applicable to more than one carrier or an entire sector. For discussion purposes, this description focuses on the carrier example. Those skilled in the art who have the benefit of this description will realize how the disclosed example is applicable to interference load measurement and control for an entire sector or an entire base station, for example.

The scheduler reverse link load control module 40 for the base station 30 performs various functions to determine an amount of interference caused by a current call load and other factors that can influence the amount of interference. In the illustrated example, the mobile stations 22 and 24 are part of the active cell load component for a carrier used by both mobile stations 22 and 24. In the same example, the mobile station 26 is currently controlled by the base station 32. The communications with the base station 30 during the handoff mode are considered part of the active load component for base stations 30 and 32 because the mobile station 26 is controlled by the base stations 30 and 32 for purposes of power management, for example.

In the illustrated example, the mobile station 28 does not communicate intentionally with the base station 30. At the same time, however, signals transmitted by the mobile station 28 schematically shown at 42 are being received at the base station 30 and constitute other cell interference and contribute to the total call load of base station 30. Of course, the mobile station 28 contributes to the total call load of the base station 32.

The illustrated example also includes a jammer 50 that introduces interference at the base station 30.

The scheduler and load control module 40 is responsible for determining whether to admit a new call and to schedule users for data transmission to allocate resources on a given carrier, for example. In this example, the scheduler and load control module 40 utilizes a total call load metric for making such decisions. This represents an improvement over techniques that utilized a measured RSSI for the reasons discussed above.

FIG. 2 includes a flow chart diagram 60 summarizing an example approach for using a total call load metric. In this example, the load control module 40 measures the reverse signal strength indicator (RSSI) at 62. This is accomplished in one example using known techniques. At 64, the load control module 40 measures the active cell load component using known techniques. At 66, the load control module 40 utilizes a derived relationship (Equation (2) below) between the RSSI, the active cell load component, an other cell load component and a jammer component to determine the other cell load component and the jammer component. At 68, once the other cell load component has been determined, the active cell load component and the other cell load component are used to determine a total call load for the carrier of interest.

The total call load, the jammer component, or both can then be utilized to determine whether to admit a new call and how to allocate current RF resources for scheduling users, for example.

The RSSI measured at a base station i is expressed in one example in terms of four components: thermal noise N^{TH}, jammer J, active cell X^{act} and other cell X^{0c}:

$${RSSI}_{i} = {N}_{i}^{TH} + {J}_{i} + {\sum }_{i ∈ {A}_{j}} {P}_{cdma , j} + {\sum }_{j ∉ {A}_{i}} {P}_{cdma , j} + {N}_{i}^{TH} + {J}_{i} + {RSSI}_{i} ⌊ {X}_{i}^{act} + {X}_{i}^{oc} ⌋ \qquad ( 2 )$$

This example includes exploiting the above relationship between the RSSI components for determining the values of the thermal noise plus jammer component Nᵢ^{TH}+Jᵢ and the “other cell” load interference component Xᵢ^{0C} based on Equation (2) and measurements of RSSIᵢ and Xᵢ^{act}. Once the “other cell” load component is determined, the total call load Xᵢ^{total}=Xᵢ^{act}+Xᵢ^{0c} is known and can be used as a significant and reliable input for overload control and reverse link scheduler algorithms, for example.

One example includes determining an estimate of Nᵢ^{TH}+Jᵢ and Xᵢ^{0c} using simultaneous measurements of RSSIᵢ and Xᵢ^{act}. In one example, RSSI is measured at baseband in the reverse link of the radio, and X^{act} is measured at the channel element ASIC using known techniques. Sampling N sets of these measurements at a high rate, such as every 1.25 msec for CDMA 2000 and every 1.67 msec for 1xEVDO, provides a time correlation between the active cell load and RSSI over a period of the N samples. If the RSSI and Xᵢ^{act} are sampled fast, then the thermal noise plus jammer term can be assumed constant in Equation (2) for the duration of the N samples (i.e., the noise power can be assumed constant and independent of time).

Equation (2) is solved in one example by assuming an average value for the other cell load component Xᵢ in the time interval of the N samples. In this case Equation (2) becomes:
RSSI_{i,j}(1−X_{i,j}^{act})= N̅ᵢ̅^̅{̅T̅H̅}̅+̅J̅ᵢ̅+RSSI_{i,j} _̅{̅X̅ᵢ̅^̅{̅0̅c̅}̅}̅ (3)
where
i=CDMA/UMTS carrier index
j=time sampling index, 1≦j≦N
N̅ᵢ̅^̅{̅T̅H̅}̅+̅J̅ᵢ̅=average value of thermal noise plus jammer power to be estimated in the N sample period
X̅ᵢ̅^̅{̅0̅c̅}̅=average “other cell” load component in the N sample period.

For most cases, N=8 (i.e. 8 sample measurements are used to minimize Equation (4)) is sufficient to obtain good accuracy. This means accurate estimates of total call load and the noise plus jammer component can be obtained every 10 milliseconds. Additional IIR filtering techniques can be used to smooth the estimates, and provide prediction values in future frames.

The average values over the sample period provides an ability to determine the desired metric(s). In one example “determining” the desired metric includes estimating it to a reasonable degree of accuracy to render the metric reliable. This description includes “estimating” as one example technique of “determining” a value. For example, one determined other cell load component is an estimated value.

The left hand side of Equation (3) is a known set of N values measured at the base station i at N consecutive times. These values are based on the measurements of the RSSIᵢ and Xᵢ^{act}. On the right hand side of Equation (3), there are two unknowns to be determined: the average thermal noise plus jammer N̅ᵢ̅^̅{̅T̅H̅}̅+̅J̅ᵢ̅ and the average other cell call load X̅ᵢ̅^̅{̅0̅c̅}̅. In this example, the previously derived Equation (2), which under the conditions stated above is valid, allows obtaining an estimate of N̅ᵢ̅^̅{̅T̅H̅}̅+̅J̅ᵢ̅ and X̅ᵢ̅^̅{̅0̅c̅}̅.

In one example, Equation (3) is solved by assuming the following linear model:
N̅ᵢ̅^̅{̅T̅H̅+̅J̅}̅ᵢ̅=constant in the N sample interval; and
X̅ᵢ̅^̅{̅0̅c̅}̅=constant in the N sample interval.
In this case, the solution can be computed by minimizing the following sum

$${\sum }_{j = 1}^{N} {[ {RSSI}_{i , j} ( 1 - {X}_{i , j}^{act} ) - \overline{{N}_{i}^{TH} + {J}_{i}} + {RSSI}_{i , j} \overline{{X}_{i}^{oc}} ]}^{2} \qquad ( 4 )$$

with solutions

$$\begin{matrix}\overline{{N}_{i}^{TH} + {J}_{i}} = \frac{\begin{matrix}[ ( {\sum }_{j = 1}^{N} {RSSI}_{i , j}^{2} ) ( {\sum }_{j = 1}^{N} {RSSI}_{i , j} ( 1 - {X}_{i , j}^{act} ) ) - \\ ( {\sum }_{j = 1}^{N} {RSSI}_{i , j} ) ( {\sum }_{j = 1}^{N} {RSSI}_{i , j}^{2} ( 1 - {X}_{i , j}^{act} ) ) ]\end{matrix}}{[ N ( {\sum }_{j = 1}^{N} {RSSI}_{i , j}^{2} ) - {( {\sum }_{j = 1}^{N} {RSSI}_{i , j} )}^{2} ]} \\ and \\ \overline{{X}_{i}^{oc }} = \frac{[ N ( {\sum }_{j = 1}^{N} {RSSI}_{i , j}^{2} ( 1 - {X}_{i , j}^{act} ) ) - ( {\sum }_{j = 1}^{N} {RSSI}_{i , j} ) ( {\sum }_{j = 1}^{N} {RSSI}_{i , j} ( 1 - {X}_{i , j}^{act} ) ) ]}{[ N ( {\sum }_{j = 1}^{N} {RSSI}_{i , j}^{2} ) - {( {\sum }_{j = 1}^{N} {RSSI}_{i , j} )}^{2} ]}\end{matrix}$$

Another example includes solving Equation (2) using a linear model for the time correlation of the other cell load component Xᵢ^{0c}. This example can be considered an enhancement model to the constant other cell load model assumptions, because it allows capturing quick changes of the other cell load for the carrier during the observation period. The linear model of this example accommodates linear changes in the other cell load during the period containing the N samples. In this case the model equations are given by:
N̅ᵢ̅^̅{̅T̅H̅}̅+̅J̅ᵢ̅=constant in the N sample interval; and
X_{i,j}^{0c}=αᵢ+βᵢ(j−1) with 1≦j≦N where αᵢ and βᵢ are constant in the N sample interval.

In this example the average other cell load in the N sample period is given by:

$$\overline{{X}_{i , j}^{oc}} = \frac{1}{N} {\sum }_{j = 1}^{N} {X}_{i , j}^{oc} = {α}_{i} + \frac{{β}_{i} ( N - 1 )}{2}$$

where
N̅ᵢ̅^̅{̅T̅H̅+̅J̅}̅ᵢ̅, αᵢ and βᵢ are the three parameters obtained by minimizing the sum:

$${\sum }_{j = 1}^{N} {[ {RSSI}_{i , j} ( 1 - {X}_{i , j}^{act} ) - \overline{{N}_{i}^{TH} + {J}_{i }} + {RSSI}_{i , j} ( {α}_{j} + {β}_{j} ( j - 1 ) ) ]}^{2} \qquad ( 5 )$$

This example involves the inversion of a 3×3 system of linear equations. One difficulty in solving Equations (4) or (5) is when there is no time correlation between the active call load and RSSI. This occurs when Xᵢ^{act}≈0, (i.e., there are no calls in the carrier). In this case it is not possible to separate the other cell load from the thermal noise plus jammer terms. In fact, the solution to Equations (4) or (5) when Xᵢ^{act} is small is given by N̅ᵢ̅^̅{̅T̅H̅+̅J̅}̅ᵢ̅=0 and X̅ᵢ̅^̅{̅0̅c̅}̅=1, which corresponds to pole capacity and is incorrect. Accordingly, in one example, when the measured values of Xᵢ^{act}=0, the solutions to Equations (2), (4) and (5) are biased and are not used.

In one example, for values of Xᵢ^{act}<0.4, the correlations between the active call load and RSSI are too weak to allow separating the other cell load X^{0c} from the thermal noise plus jammer N^{TH} and J component in Equation (2). In this example, if the measured active call load Xᵢ^{act}<0.4 and assuming the thermal noise plus jammer power is kept constant during the N samples period, the other cell load can be estimated by using the fact that the standard deviation σ of the “other cell” interference power is proportional to the “other cell” interference power:
σ[RSSIᵢXᵢ^{0c ]=σ[}RSSIᵢ(1−Xᵢ^{act})−Nᵢ^{TH}−Jᵢ]=σ[RSSIᵢ(1−Xᵢ^{act})]≈κEᵢ^{0c} (6)
where κ is a constant and

$${E}_{i}^{oc} = \overline{{X}_{i}^{oc}} \frac{I}{N} {\sum }_{j = 1}^{N} {RSSI}_{i , j}$$

The following equation provides an estimate for determining the other cell load X^{0c} when the active call load X^{act} is less than 0.4:

$$\overline{{X}_{i}^{oc}} \approx \frac{σ ⌊ {RSSI}_{i} ( 1 - {X}_{i}^{act} ) ⌋}{\frac{κ}{N} {\sum }_{j = 1}^{N} {RSSI}_{i , j}}$$

Given the determined estimate of the other cell load X^{0c}, the total call load X^{TOTAL} is obtained using Equation (2), which provides an estimate of the thermal noise plus jammer component Nᵢ^{TH}+Jᵢ.

Determining the total call load provides for improved scheduling. A better indication of whether a new call will introduce problematic interference levels can be achieved when using total call load as a scheduling metric. The following example scheduling technique has several advantages compared to arrangements that rely solely upon RSSI measurements for determining whether to allow a new call into a cell or scheduling callers, in general.

When it comes to scheduling data users, their impact on existing voice users (at least within the same cell) must be considered. If coverage is an issue, then some measure of RSSI is one appropriate metric to consider. Overall system stability in a power controlled system is also recognized as a key control parameter (and is considered a linking factor between voice outage and data throughput since this affects voice and data mobiles) and for this, a measure of call load is the better metric for consideration.

The call load is a good measure of instability regardless of the value of the total jammer signal. However, jammer signal affects the absolute maximum coverage permitted in a cell. The jammer components, unlike the Ioc estimate, is not coupled via the power control feedback loop to the CDMA interference, and thus does not compete with the latter which experiences an increase with additional loading but the jammer components do not. In other words, the effect of a jammer component on coverage is static and not dynamic.

In one example, maintaining a minimum coverage radius for a cell includes imposing limits on the maximum RSSI or RoT permitted. The jammer value, which is determined based on the average RSSI and corresponding call load measurements, is used to determine a call load threshold. The final call load threshold is chosen as the minimum of the thresholds derived for minimum coverage and for stability. This together with the current call load estimate and mobile station transmit power headroom availability is used to ultimately select the rate of each scheduled user.

Note that so long as a mobile station (MS) transmitting data has sufficient power, it may be scheduled to transmit at a certain format. Such a user contributes to a call load and RSSI increase. The scheduler in one example guarantees that the increase in either will not cause them to exceed the desired limits more than an acceptable fraction of the time. One feature of the example scheduler described below is setting margins, which ensure that the call load and RSSI stay within desired limits, after deciding which users to schedule for transmission and allocating rates accordingly.

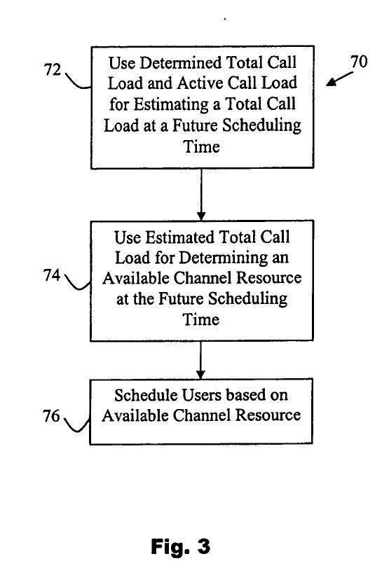

FIG. 3 includes a flow chart diagram summarizing one example approach. The flow chart 70 includes a first step at 72 where the determined total call load is used for predicting a call load at a future scheduling time. At 74, the predicted call load is used for determining an available channel resource at the scheduling time. The available resource information is then used at 76 for scheduling mobile stations including determining how many users to schedule, for example. A particular example is described below.

In one example, each base station (BS) performs the operations in the scheduling algorithm every T_{schledule} or T_{frame} seconds (e.g., 10 ms). The scheduling operations are distributed across BSs such that each BS independently determines the RPDCH rates for the scheduled type data users who it is controlling (i.e., for which it is the single handoff leg, or for which it is the primary serving BS in case of two softer handoff legs). The example scheduling strategy takes into account information about the channel of the users (at least in an average sense), the status of their buffers and is based on the idea that when there are bursty and random arrival patterns of traffic in users' buffers, statistical multiplexing (i.e., assignment of all available RL resources to the users with data to send) leads to better utilization and minimizes overall delay. The channel conditions (again, in an average sense) are used to accord priority to the competing users who all have data to send. In one example, better-placed users are picked subject to fairness to minimize transmit power and system interference. Several users may be scheduled jointly during a given frame when they all have data to send and the right number of them needs to be picked. One example includes scheduling the multiple users such that the overall RoT or equivalent call load resulting from the multiple user transmissions has a relatively smaller occurrence of high overshoots (i.e., the RoT tail probability is small for a large mean).

The jammer power at the BS derived from total received power measurements is a measure of the coverage and the call loading is a measure of the stability. Given a minimum required coverage (or RoT limit) in one example allows translating this to a certain call load threshold limit given the jammer power. The lower of the limits of call load for coverage and stability decides the scheduler operations. The scheduling algorithm seeks to manage this primary resource of available call load. In order to allow flexibility in the utilization of the allowed resource, more than one data user may be permitted to transmit at a time. Maintaining fairness in one example includes making use of a proportional-fair based prioritization. The example scheduling algorithm makes use of knowledge of the total received power at the BS, the channel conditions and channel gain of each scheduled type data mobile controlled by BS. Alternatively, an average geometry metric obtained from FL measurements may be used in lieu of channel gain, just for priority computation purposes.

For discussion purposes, consider an example BS (with an identifier k) that will schedule (and control the transmission rate of) a transmission by a mobile station i for the n^{th} frame where each interval or frame length is given by T_{schedule}. In one example, the exact instant of scheduling decisions performed at the BS is ahead of the start of the n^{th} frame by Delay_{BStoMS} time units (e.g., in terms of seconds).

This example uses several inputs to the scheduling algorithm. One is RSSIₖ(n), which is the latest measurement of the total received power at the BS to be used (after passing through a predictor) for scheduling and rate control decisions for frame n. In one example, this measurement is outdated by Delay_{BSRSSI}. In other words, the measurement being used at the current scheduling instant was actually made Delay_{BSRSSI} time units ago. In the best case, this delay is less than a frame and in the worst case it is as old as N frames. In one example, the BS has knowledge of the value of Delay_{BSRSSI}.

For each MS (with id i) having BS k in its active set, [E_{cp}/I₀]_{i,k}(n) is the pilot signal to noise ratio (SNR) estimate of the mobile station i. In one example, this quantity is determined as the ratio of two quantities available in the baseband processor. The first quantity is R_{i,k,pilot}(n), which is the latest measurement of the received RPICH “energy” or SNR from mobile i. In one example, this is obtained post pilot weighted combining across all paths and antennas. The value for this quantity is delayed by Delay_{BSpilot}. In other words, the value used at the current instant of scheduling for a future frame n is actually measured Delay_{Bspilot} time units ago. The second quantity, C(n), is the corresponding value of the total power coming in for baseband processing after AGC scaling. This measurement is also delayed by Delay_{BSpilot}.

Another input to the scheduling algorithm is TPR_max_xmit_{i,k}. This is an estimate of the available transmit to pilot (T/P) headroom at the mobile i. Given the maximum transmit power of the mobile and T/Ps of the existing other channels (not RPDCH), this maps directly to the current pilot transmit power of the mobile i. In one example, this is based on the TPR_max_xmit_{i,k} or equivalent RPICH transmit power that is transmitted (refreshed) periodically by the mobile station on the request channel R-REQCH. Another example includes optionally determining this by tracking the power control commands transmitted to MS with bit error PCₑᵣᵣ.

Another input is TPR_{l,l,k}(n), which is the traffic to pilot power ratio (TPR) of any given channel I of MS i in this BS k. In one example, this measurement is delayed by Delay_{BSpilot} (i.e., the value used at the current instant of scheduling for a future frame n is actually measured Delay_{Bspilot} time units ago).

Given these quantities, the following equation is one way of expressing the current estimate of call load:

$${\hat{X}}_{k} ( n ) = \frac{1}{f} {\sum }_{i ∈ Active ( k )} {\sum }_{l} {( \frac{{E}_{cp}}{{I}_{o}} )}_{i , k} {TPR}_{l , i , k} {I}_{l , i , k} ( n - {Delay}_{BSpilot} - {Delay}_{BStoMS} ) \qquad ( 8 )$$

where

f is a frequency reuse efficiency that is X^{active}/X^{total} (i.e., active call load divided by the total call load), each of which is determined as described above;

E_{cp} is the pilot chip energy determined in a known manner;

Iₒ is the power spectral density or RSSI as determined above;

TPR is the traffic to pilot ratio; and

I is an indicator function that indicates whether the channel l will be transmitting at the instant of scheduled transmission.

In one example, the TPRs are measured or looked up for all channels of all MSs having this BS in the active set (i.e., all MSs that are scheduled, rate controlled, autonomous on the R-PDCH with corresponding RPDCCH, CQICH or mobiles with only R-FCH, R-DCCH or pre-rev D R-SCH active). The TPR is unity for the primary pilot and the appropriate value of secondary to primary ratio (SPR) for the secondary pilot. I(x) is the indicator function of activity of a given channel at frame x. In one example, I(x) provides an indication of a level of MS activity on the channel.

One example includes the recognition that the above estimate of load is too coarse and needs to be refined based on projected values of TPR and channel activity indicators as well as predicted values of E_{cp}/Iₒ T\tilde{P}R_{l,i,k} is a projected TPR for the channel l of mobile i active in this BS k at frame n, which is Delay_{BstoMs} time units into the future from the current instant of scheduling. In one example, for all channels except the RPDCH, RPDCCH and RCQICH these are measured (or looked up) values of TPR_{l,i,k} from Delay_{Bspilot} time units ago. The BS is programmed to use a selected number of such recent values for determining T\tilde{P}R_{l,i,k}.

In one example, the BS derives knowledge of the activity indicator function Ĩ_{l,i,k}(n) of the RPDCH from the already known RPDCH TPRs granted/transmitted in the recent past (up to a few T_{schedule}s ago), the CRC events on soft combining previous sub-packets, the synchronous HARQ timing, and the latest buffer status report of the MS i, and if active, its TPR and associated RPDCCH TPR and SPR Delay_{BStoMS} time units into the future. In the case of RCQICH, the TPR of full versus differential reports can be accounted for depending on what is expected. If the BS has sent an ACK to a particular mobile for the last transmission on frame n_{last-harq(n)} using the hybrid ARQ channel instance of frame (n) and if that mobile seemingly has fresh packets to send in its queue, then the BS projects the same TPR (in rate controlled mode assuming keep command). In one example, this can be expressed as:
T\tilde{P}R_{l,i,k}(n)=TPR_{l,i,k}(n_{last-harq(n)})for l ∈{RPDCCH,RPDCH,Secondary} (9)

The indicator function Ĩ_{l,i,k}(n) per mobile per channel that indicates whether or not that channel l (typically RPDCH and associated secondary and RPDCCH) will be transmitting at the instant of scheduled transmission Delay_{BstoMS} into the future is set to zero in one example if it is expected to be switched off due to empty queues or its last packet on the same HARQ channel instance did not succeed in its final hybrid ARQ attempt. The BS may or may not schedule a new packet for that mobile during the nth frame at a new possibly discontinuous rate, but there is no a priori assumption of a transmission using the last TPR and a consequent reservation of load.

The

$$\frac{{\tilde{E}}_{cp}}{{I}_{o i , k}} ( n )$$

is the prediction of the pilot SNR for each mobile i active at this BS k (based on measurements made Delay_{BSpilot} time units ago) for the frame n that is to begin Delay_{BStoMS} time units into the future.

The improved prediction of the apriori call load \tilde{X}ₖ⁻(n) estimated for frame n due to pre-existing transmissions is estimated in one example by the BS k via the following equation that makes use of the pilot SNR predictions, projected TPRs and activity indicators for each channel 1 of each mobile i active in this base station k:

$${\tilde{X}}_{k}^{-} ( n ) = \frac{1}{f} {\sum }_{i ∈ Active ( k )} {\sum }_{l} ( \frac{{\tilde{E}}_{cp}}{{I}_{o i , k}} ( n ) ) T \tilde{P} {R}_{l , i , k} {\tilde{I}}_{l , i , k} ( n ) \qquad ( 10 )$$

The available call load X_{avail,k}(n), for potentially making fresh schedule grants or changing the rate assignments for fresh packets via rate control commands to previously scheduled mobiles is computed in this example according to:
X_{avail,k}(n)=min(\hat{X}ₖ^{lim,stab}−m arg in1,\hat{X}ₖ^{max,cov}(n)−m arg in2)−\hat{X}ₖ⁻(n) (11)

\hat{X}ₖ^{max,cov}(n) is obtained based on the jammer estimation equations described above, which is in turn driven by the latest RSSI measurement (or prediction). Updating \hat{X}ₖ^{max,cov}(n) as a function of n is important to account for changes in jammer components. The margins (margin 1, margin 2) are selected to ensure that the load overshoot probabilities are within desired limits. The margins in one example are designed to take into account sudden unannounced, low rate, autonomous transmissions from some mobiles during frame n.

The number of transmitting users Nₜₓ(n) that will be scheduled to use the available call load is decided based on the lower of the number attempting to transmit or the number that can be accommodated within X_{avail,k}(n). This can be expressed as:
Nₜₓ(n)=min└N_{data}(n),Nₜₓ_{_{—}}ₘₐₓ(X_{avail,k}(n))┘ (12)

Based on X_{avail,k}(n), the appropriate number of simultaneous users to be scheduled N_{th —max}(X_{avail,k}(n)) is determined via table look up in one example. The actual number of users that have data to transmit during frame n is given by N_{data}(n). This is in order to distribute the available call load among a reasonable number of users to control the actual call load overshoot and increase utilization. It is possible that Nₜₓ(n)=0 due to X_{avail,k}(n)<=0. If X_{avail,k}(n)<0 then it may be necessary to reduce the rates (and powers) of previously transmitting mobiles either via gradual RC down commands or more drastically via new schedule grants with lowered rates.

One example includes prioritizing scheduled mobiles. The priority of each MS within a scheduling round in one example is expressed as:

$${Priority}_{i , k}^{( n )} = \frac{1}{{WinThruput}_{global , i} \cdot Window\_i} \times log [ \begin{matrix}1 + \\ ( \begin{matrix}( \begin{matrix}1 + {\sum }_{l ∉ \{ RPDCH , RPDCCH , CP \}} {TPR}_{l , i , k} ( {n}_{REQCH} ) + \\ TPR\_max {\_xmit}_{i , k} ( {n}_{REQCH} )\end{matrix} ) \times \\ {\sum }_{w = n - window\_i}^{n} ( \frac{\frac{{\tilde{E}}_{cp}}{{I}_{o i , k}} ( w )}{{\prod }_{m = {n}_{REQCH}}^{w} {PC}_{k , i} ( m )} )\end{matrix} )\end{matrix} ] \qquad ( 13 )$$

This is a proportional fairness algorithm, which uses generally known techniques. There are differences, however, between this example and known proportional fairness schedulers in addition to the use of call load values for scheduling as described above. The last terms in Equation (13) are used to correct for discrepancies between the E_{cp}/Iₒ measurement and the actual value at the scheduled transmission time (i.e., frame interval n). The denominator at the end of Equation (13) uses power control commands, PC, for making such a correction. In one example, the recent power control commands issued to mobile i by this BS k from the last request channel frame containing the mobile headroom refresh to the current scheduling instant before frame n provide an indication of the actual power at which a mobile's transmission will be received at BS k. This example approach uses a recent history of inner loop power control information to correct for changes occurring during the delay between the E_{cp}/Iₒ measurement and the actual E_{cp}/Iₒ that will exist at the scheduled transmission time. The predicted mobile transmission power provides an indication of how much of the available channel resource that mobile will consume, for example. Given this description, those skilled in the art will understand how to choose an appropriate number of the power control commands to accomplish this aspect of the example priority determination.

The window_i is a summing window to capture the sum total of pilot SNRs achieved over the targeted number of re-transmissions that achieves the desired QoS for the user's packet service. The window length (in terms of number of frames) also appears in the denominator. This is a better measure of the channel throughput when there is uncertainty in the channel and hybrid ARQ retries are aggressively resorted to. The window can be made short (up to 1 frame) if the QoS requirements force it or if the channel for the user is quite predictable over the total Delay_{BSpilot}+Delay_{BstoMS}, (i.e. for near stationary users). In such a case, there may be added benefits due to fast channel sensitive, Doppler sensitive scheduling or both.

The TPR_{l,i,k}(n_{REQCH}_{_{—}}ₗₐₛₜ) is considered for each channel 1 of every mobile i in this BS k at the time of the last request channel frame containing the mobile headroom refresh.

Among the MS who have data to transmit, one example includes selecting the top Nₜₓ(n) mobiles as the mobiles that will be allowed to transmit on the RPDCH. In one example, some of these may be assigned schedule grants and others may be sent rate control commands depending on the selected rate of transmission and the mode they were in prior to frame n.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A probe head apparatus for connection to an amplifier comprising:
First and second signal-ground transport elements disposed in fixed relationship to each other, each signal-ground transport element having a probe tip, each signal-ground transport element configured to provide inherent spring properties.

14. An apparatus as recited in claim 13 wherein the first and second signal-ground transports have substantially the same configuration.

15. An apparatus as recited in claim 13 wherein the signal-ground transport comprises a micro-coaxial line having a portion configured as a loop.

16. An apparatus as recited in claim 15 wherein the loop is planar.

17. An apparatus as recited in claim 15 wherein the loop includes a radius no smaller than a bend radius limit of the micro-coaxial line.

18. (canceled)

19. (canceled)

20. (canceled)

21. (canceled)

22. (canceled)
